(19) United States
(12) Patent Application Publication
(10) Pub. No.: US 2023/0029285 A1
(43) Pub. Date: Jan. 26, 2023

(54) SIDE WALL PORTION OF AN AIRCRAFT CABIN, FUSELAGE STRUCTURE AND AIRCRAFT HAVING THE SAME

(71) Applicant: Airbus Operations GmbH, Hamburg (DE)

(72) Inventors: Peter LINDE, Hamburg (DE); Camilla BRODALE, Hamburg (DE)

(21) Appl. No.: 17/863,113

(22) Filed: Jul. 12, 2022

(30) Foreign Application Priority Data
Jul. 21, 2021 (EP) 21186989.6

(51) Int. Cl. B64C 1/14; B64C 1/12; H05B 1/02

(52) U.S. Cl. CPC B64C 1/14; B64C 1/12; H05B 1/0236

(57) ABSTRACT

A side wall portion of an aircraft has an integrated structural battery and heating member. The side wall portion has a plurality of solar cells arranged on an inner circumferential surface of a window frame structure. The electrical energy produced by the solar cells is stored in the structural battery and output to the heating members, so as to heat the side wall portion. With this a thinner thermal insulation of the fuselage structure is possible in the vicinity of the seats so as to allow for an additional seat in the abreast direction.

### CROSS-REFERENCES TO RELATED APPLICATIONS

This application claims the benefit of the European patent application No. 21186989.6 filed on Jul. 21, 2021, the entire disclosures of which are incorporated herein by way of reference.

### FIELD OF THE INVENTION

The invention relates to a side wall portion of a cabin of an aircraft. The invention further relates to a fuselage structure for an aircraft and an aircraft.

### BACKGROUND OF THE INVENTION

In an effort to increase passenger capacity there is an idea to reduce the thickness of the frame. While structurally a non-issue, the reduced thickness may cause colder temperatures.

### SUMMARY OF THE INVENTION

It is an objective of the invention to allow an increase of the number of seats in an abreast direction in an aircraft.

The invention provides a side wall portion of a cabin of an aircraft, the side wall portion comprising an energy source configured for supplying electrical energy; and a heating member electrically coupled to the energy source and configured for heating the side wall portion.

Preferably, the energy source includes at least one energy producer device configured for generating electrical energy.

Preferably, the energy producer device is a solar panel.

Preferably, the energy source includes at least one energy storage device configured for storing electrical energy.

Preferably, the energy storage device is a structural battery. Preferably, the structural battery is integrated into the side wall portion.

Preferably, the heating member includes a heating element that is integrated into the side wall portion.

Preferably, the side wall portion has a side wall lining and the energy source is integrated into the side wall lining.

Preferably, the side wall portion has a side wall lining and the heating member is integrated into the side wall lining.

Preferably, the side wall lining has a layer structure comprising a plurality of functional layers, and the energy source, preferably the energy storage device, and/or the heating member are formed by a portion of the functional layers.

Preferably, the heating member is arranged to be closer to a cabin interior, when the side wall portion is in operating condition.

Preferably, the energy storage device is arranged adjacent to the heating member and separated therefrom by an electrically isolating layer.

Preferably, the heating member comprises a partially coated carbon fiber, wherein the coating is electrically isolating.

Preferably, the layer structure comprises a back cover portion that is arranged further outward than any of the energy source, preferably the energy storage device, and/or the heating member.

Preferably, the back cover portion includes a foam layer that is arranged next to the energy source, preferably the energy storage device, and/or the heating member.

Preferably the back cover portion includes another foam layer that is arranged spaced apart from the foam layer.

Preferably, the/each foam layer has an isolating layer attached to it which separates the foam layer from an adjacent layer.

Preferably, the back cover portion includes a thermal insulation layer which is the outermost layer.

The invention provides a fuselage structure for an aircraft, the fuselage structure comprising an outer skin, a window frame structure, and at least one preferred side wall portion, wherein the outer skin and the side wall portion each have an opening for a window, wherein the window frame structure is arranged between the outer skin and the side wall portion at the location of the opening, and the energy source, preferably the energy producer device, is disposed on the window frame structure.

Preferably, the energy source, more preferably the energy producer device, is disposed on the window frame structure such that the energy producer device is accessible for light through the opening.

Preferably, the energy source is disposed on an inner circumferential surface of the window frame structure.

Preferably, the side wall portion has a smaller thickness than an adjacent fuselage portion.

Preferably, the fuselage structure further comprises a top fuselage portion and/or a bottom fuselage portion that are arranged adjacent to a first side wall portion and a second side wall portion.

Preferably, the side wall portions are arranged such that at seat level an inner diameter of the fuselage structure is larger than an inner diameter measured along a direction that does not intersect with the side wall portion.

Preferably, the outer skin and the side wall portion are spaced apart by a plurality of frames, clips, and/or stringers.

Preferably, foam is arranged between the outer skin and the side wall portion.

The invention provides an aircraft comprising a cabin, wherein a side wall of the cabin has at least one preferred side wall portion and/or wherein the aircraft comprises a preferred fuselage structure.

Embodiments of the invention are described in more detail with reference to the accompanying schematic drawings.

An idea of the invention is a device and method for heat dissipation in the sidewall lining by thin integrated heating elements, such as printed heating spirals, powered by solar cells, placed in the bright area between inner and outer window. The solar cells are capable of buffering energy into thin, structurally integrated batteries, integrated in the side wall lining. To reduce the energy consumption, each heating spiral is preferably placed adjacent to a structural battery, which dissipates some constant heat during discharging.

It may be noted that the solar cells are placed in the brightest location, which is still protected from the weather, and thus the most efficient cells can be chosen.

At first, cables enter to the battery from the solar cells that provide a charging function. Micro controllers determine extent of charging. From the battery a cable leads to the heating spiral, also via micro controllers, steered by temperature sensors.

It should be noted that the structural battery, preferably integrated in the side wall lining, itself dissipates energy thereby providing a surface temperature of up to +35° C. This allows reduction of a need for energy led into the heating spiral.

In another instance, the heating element may comprise a layer of carbon fiber reinforced plastic (abbreviated CFRP) material that is included in the inner cover of the sandwich side wall lining.

The invention may exhibit, in particular, any of the following advantages. It should be noted that not all advantages are required to be present at the same time or with the same intensity.

The ideas herein enable heating that reduces the cold air convection from thin thermal insulations, such as, e.g., at reduced frame height (i.e., thereby enabling an increased number of seats abreast).

Furthermore, joule heating can be realized without system power cables to a board generator.

The preferred location for solar cells/panels is used, which is brightest available and protected from weather.

In an embodiment, the heat dissipation from the structural battery layer within the side wall lining can be utilized to reduce the energy needed for the heating spirals.

Preferably, solar cells are attached in window frame. The structural batteries may be laminated into the side wall linings inner cover. Heating spirals can be printed on one of the CFRP layers. It is also possible that the CFRP layer in side wall lining's inner cover is used as the heating element, which preferably includes coated carbon fibers. Micro-controllers for controlling the system may be integrated into the electrical wiring.

The solar cells charge the structural batteries. The heating spirals, or CFRP heating layer exert the Joule effect when a temperature sensor triggers and the structural battery provides a basic temperature, thereby reducing energy need in the heating element.

### BRIEF DESCRIPTION OF THE DRAWINGS

The invention is described in more detail with reference to the accompanying schematic drawings. Therein:

FIG. 1 depicts an embodiment of an aircraft;

FIG. 2 depicts a cross section of a fuselage of the aircraft;

FIG. 3 depicts a detailed cross section of a side wall portion;

FIG. 4 depicts an exemplary perspective view of a side wall portion;

FIG. 5 depicts a more detailed view of the side wall portion; and

FIG. 6 depicts a cross section of the side wall portion.

### DETAILED DESCRIPTION OF THE PREFERRED EMBODIMENTS

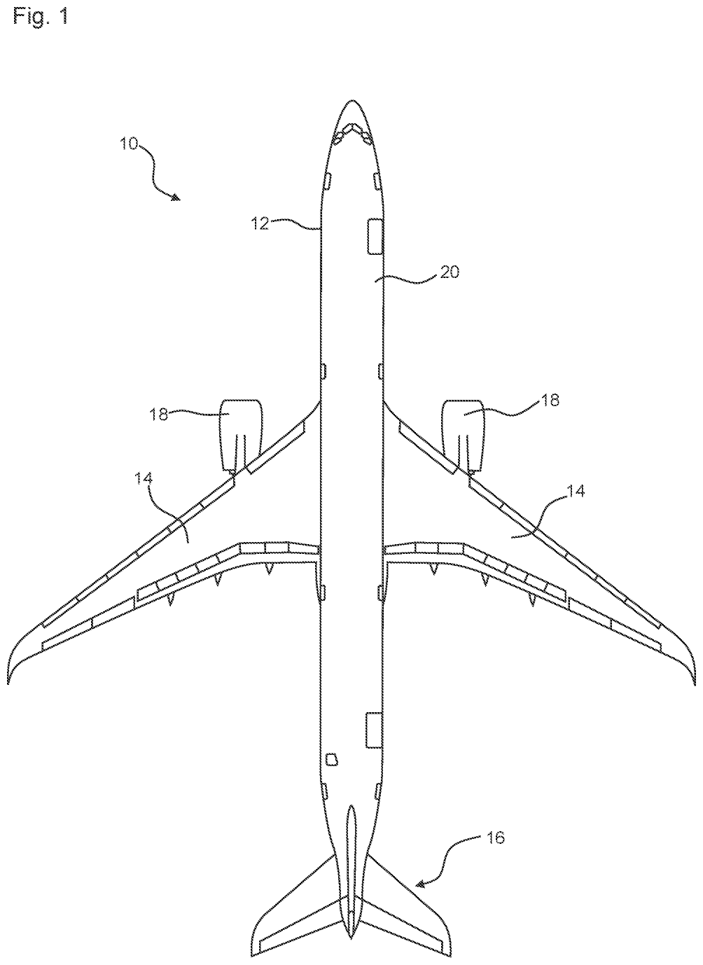

FIG. 1 illustrates an aircraft 10 having a fuselage 12. The aircraft 10 comprises a pair of wings 14 and a tail plane section 16. Furthermore, the aircraft comprises engines 18 for propulsion. The fuselage 12 comprises a cabin 20 for passengers.

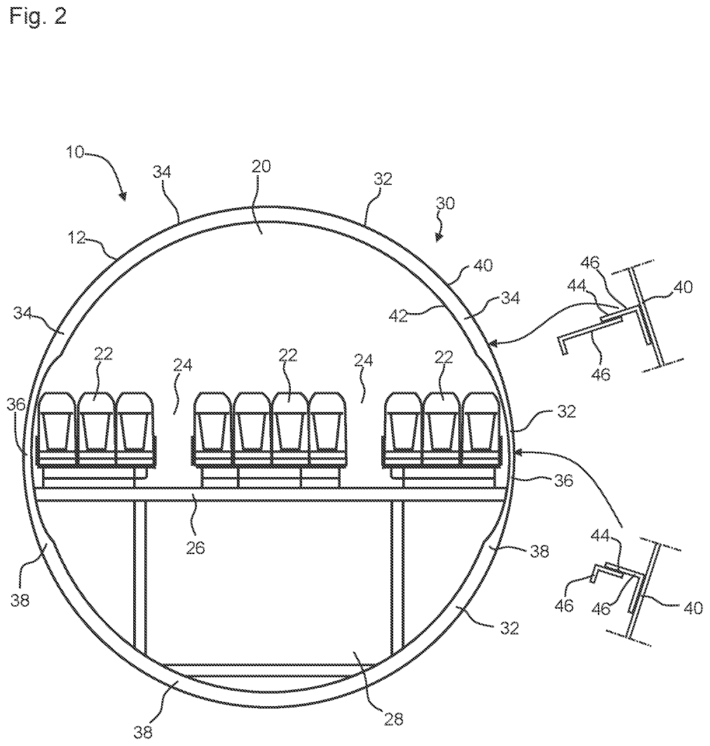

FIG. 2 shows a cross section in the abreast direction of the fuselage 12. The cabin 20 includes a plurality of seats 22 and aisles 24. Here, the seats 22 are arranged in a 3-4-3 pattern abreast. A floor 26 divides the cabin 20 from the cargo area 28, for example.

As depicted in FIG. 2, the fuselage 12 comprises a fuselage structure 30 having multiple fuselage portions 32 with different thicknesses. A top fuselage portion 34 forms the upper part of the cabin 20. The top fuselage portion 34 extends from a bit (one or two head sizes) above head height from the seats 22. The top fuselage portion 34 may have overhead compartments and other equipment typically arranged near the roof of the cabin 20. In the vicinity of the seats 22, the fuselage structure 30 comprises a side wall portion 36. The side wall portions 36 form the sides of the cabin 20. The side wall portions 36 extend from roughly below the floor 26 to a bit (one or two head sizes) above head height from the seats 22. The side wall portion 36 has a smaller thickness than the adjacent top fuselage portion 34 and a bottom fuselage portion 38 which forms the bottom of the cabin 20. The bottom fuselage portion 38 is part of the fuselage structure 30. The bottom fuselage portion 38 extends from below the floor 26. The bottom fuselage portion 38 supports the floor 26 from below. The bottom fuselage portion 38 encloses the cargo area 28.

The fuselage structure 30 comprises an outer skin 40 and an inner skin 42 that are spaced apart by I-stringers 44, for example. The I-stringers 44 may be formed from two pieces 46 that allow adjustment of the distance between the outer skin 40 and the inner skin 42. The I-stringers 44 allow for a smaller thickness of the side-wall portion 36 compared to the thickness of the top fuselage portion 34 and the bottom fuselage portion 38.

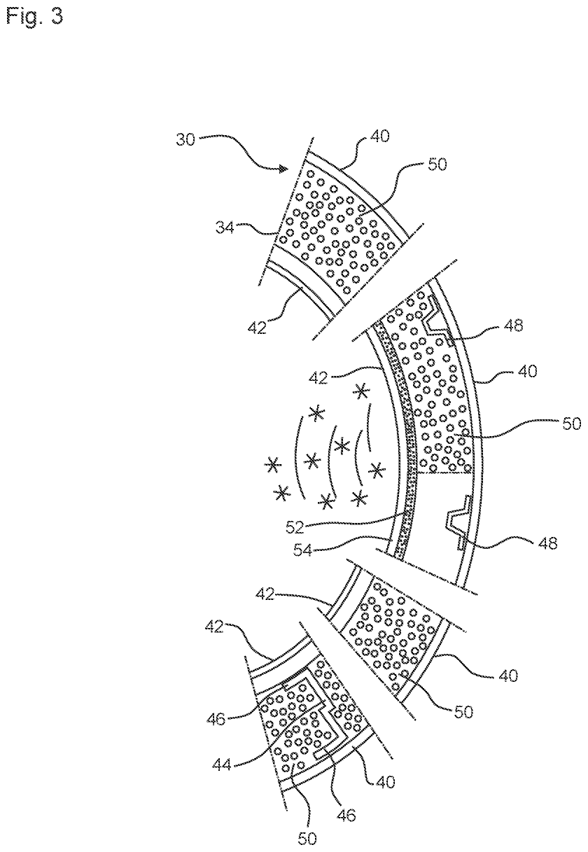

FIG. 3 depicts a cross section of a typical fuselage structure 30 in more detail. The fuselage structure 30 has the top and bottom fuselage portions 34, 38 and the side wall portion 36 arranged therebetween. The side wall portion 36 includes structural stiffeners, such as omega-stringers 48 that are attached to the outer skin 40.

Furthermore, the side wall portion 36 may include a thermal insulation 50. The thermal insulation 50 is arranged between the outer skin 40 and the inner skin 42.

The inner skin 42 may comprise an additional thermal insulation 52 that is arranged between a fuselage frame 56a or thermal insulation 50 and a side wall lining 54. The side wall lining 54 faces inward into the cabin 20.

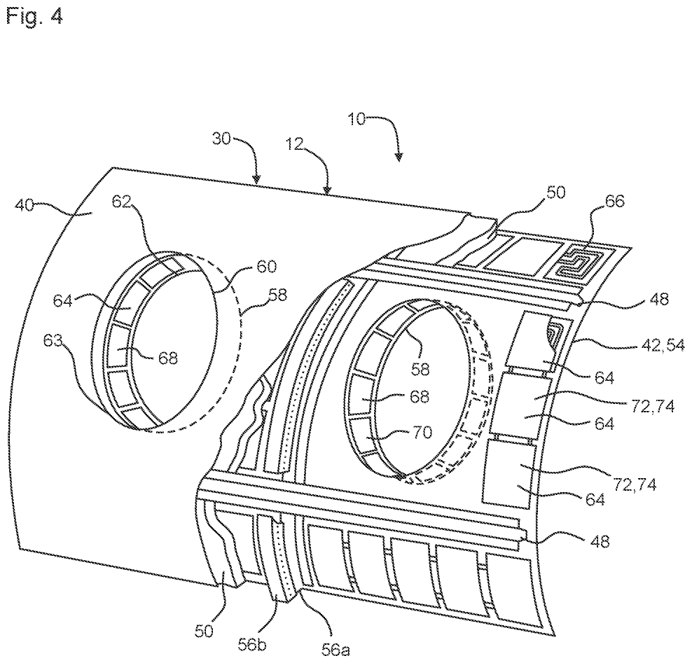

Referring to FIG. 4 through FIG. 6, the side wall portion 36 is described in more detail. The side wall portion 36 includes a fuselage frame 56a, a clip 56b and omega-stringers 48. In addition, the side wall portion 36 includes a window frame structure 58. The window frame structure 58 defines openings 60 for an inner window 62 and an outer window 63.

The side wall portion 36 includes an energy source 64 configured for producing and storing energy. The energy source 64 is electrically connected to a heating member 66 that is arranged on the inner skin 42, preferably the side wall lining 54.

The energy source 64 includes an energy producer device 68 which produces electrical energy. Here the energy producer device 68 includes a plurality of solar cells 70. The solar cells 70 are disposed on an inner circumferential surface of the window frame structure 58 and between the inner and outer windows 62, 63.

The energy source 64 further includes at least one energy storage device 72. The energy storage device 72 is disposed on the inner skin 42 or integrated into the inner skin 42, preferably the side wall lining 54. The energy storage device 72 is a structural battery 74 that may form part of the side wall lining 54.

The heating member 66 includes a heating element 76. The heating element 76 may be formed by coated carbon fibers or carbon fiber plies and use the Joule effect for generating heat. Furthermore, the energy storage device 72 may serve as a heating element 76, when charging/discharging.

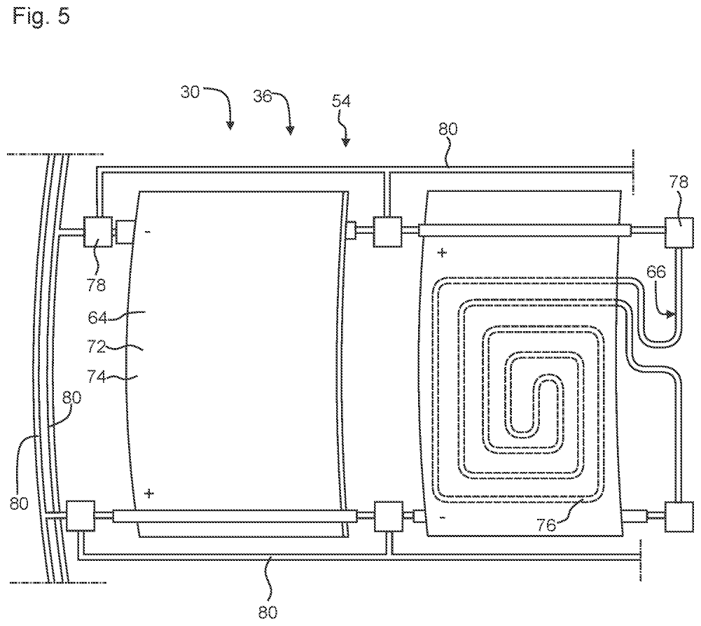

As shown more closely in FIG. 5, the side wall portion 36 may include one or more control devices 78 controlling the energy generation and storing process as well as the heating process. The energy producer device 68, the energy storage device 72 and the heating member 66 are connected via electrical cable 80 that are also coupled to the control devices 78.

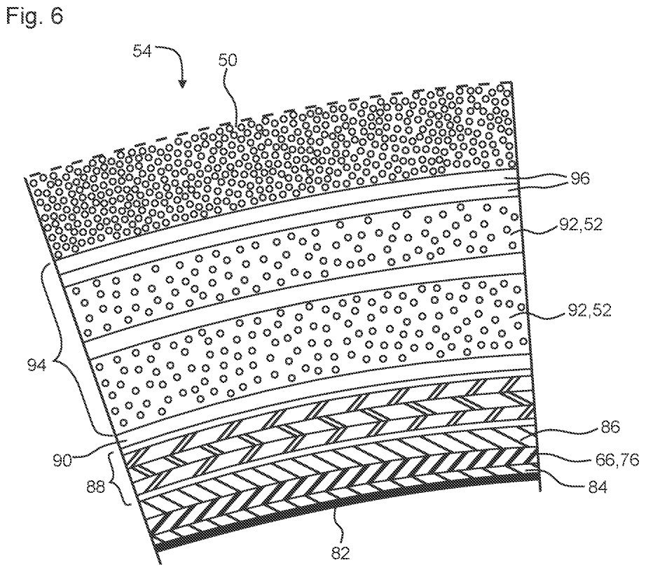

FIG. 6 illustrates the layer or laminate structure of the side wall lining 54, which will be described going outward from the cabin 20.

The innermost layer is usually a décor foil 82 that is visible to the passenger.

On top of the décor foil 82, there is usually an inner cover layer 84 that is made of a fiber composite, such as glass fiber reinforced plastic (abbreviated GFRP).

Next, the heating member 66 is arranged. Here, the heating member 66 is formed by a heating layer that may include CFRP with coated carbon fibers. The carbon fibers may be shaped in a heating spiral configuration.

The heating member 66 has on top of it an electrically isolating layer 86 that is preferably made of GFRP.

The electrically isolating layer 86 isolates a plurality of structural battery layers 88, which form the structural battery 74 or energy storage device 72.

The energy storage device 72 is covered by another isolating layer 90 and/or an organo sheet material.

Next, one or more light weight foam layers 92 form a back cover 94 of the side wall lining 54. The back cover 94 is topped by one or more isolating layers 96 made of GFRP or organo sheet material.

Then the remainder of the inner skin 42 and side wall portion 36 are arranged on top of the back cover 94.

During operation, the energy producer device 68 produces electrical energy which is stored in the energy storage device 72. The energy storage device 72 generates heat during charging. Subsequently, the control device 78 activates the heating member 66 upon determining that a temperature threshold was met. With this, a convenient and comfortable temperature can be maintained in portions of the cabin 20 which have a thinner thermal insulation. Thus, the thickness of the fuselage structure 30 may be reduced to accommodate more seats 22 in the abreast direction.

In order to allow increase of the number of seats 22 in an abreast direction, the invention proposes a side wall portion 36 that has an integrated structural battery 74 and heating member 66. The side wall portion 36 has a plurality of solar cells 70 arranged on an inner circumferential surface of a window frame structure 58. The electrical energy produced by the solar cells 70 is stored in the structural battery 74 and output to the heating members 66, so as to heat the side wall portion 36. With this, a thinner thermal insulation of the fuselage structure 30 is possible in the vicinity of the seats 22 so as to allow for an additional seat in the abreast direction.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 aircraft
12 fuselage
14 wing
16 tail plane section
18 engine
20 cabin
22 seat
24 aisle
26 floor
28 cargo area
30 fuselage structure
32 fuselage portion
34 top fuselage portion
36 side wall portion
38 bottom fuselage portion
40 outer skin
42 inner skin
44 I-stringer
46 piece
48 omega-stringer
50 thermal insulation
52 additional thermal insulation
54 side wall lining
56a fuselage frame
56b clip
58 window frame structure
60 opening
62 inner window
63 outer window
64 energy source
66 heating member
68 energy producer device
70 solar cell
72 energy storage device
74 structural battery
76 heating element
78 control device
80 electrical cable
82 décor foil
84 inner cover layer
86 isolating layer
88 structural battery layer
90 another isolating layer
92 foam layer
94 back cover
96 isolating layers

1. A side wall portion of a cabin of an aircraft, the side wall portion comprising:
an energy source configured for supplying electrical energy; and
a heating member electrically coupled to the energy source and configured for heating the side wall portion.

2. The side wall portion according to claim 1, wherein the energy source includes at least one energy producer device configured for generating electrical energy.

3. The side wall portion according to claim 1, wherein the energy source includes at least one energy storage device configured for storing electrical energy.

4. The side wall portion according to claim 1, wherein the heating member includes a heating element that is integrated into the side wall portion.

5. The side wall portion according to claim 1, wherein the side wall portion has a side wall lining and at least one of the energy source or the heating member is integrated into the side wall lining.

6. The side wall portion according to claim 5, wherein the side wall lining has a layer structure comprising a plurality of functional layers, and the at least one of the energy source or the heating member is formed by a portion of the functional layers.

7. The side wall portion according to claim 6, wherein the layer structure comprises a back cover portion that is arranged further outward than the at least one of the energy source or the heating member.

8. A fuselage structure for an aircraft, the fuselage structure comprising:
an outer skin,
a window frame structure, and
at least one side wall portion according to claim 1,
wherein the outer skin and the side wall portion each have an opening for a window,
wherein a window frame structure is arranged between the outer skin and the side wall portion at a location of the opening, and the energy source is disposed on the window frame structure.

9. The fuselage structure according to claim 8, wherein the energy source is disposed on the window frame structure such that the energy producer device is accessible for light through the opening.

10. The fuselage structure according to claim 8, wherein the energy source is disposed on an inner circumferential surface of the window frame structure.

11. The fuselage structure according to claim 8, wherein the side wall portion has a smaller thickness than an adjacent fuselage portion.

12. The fuselage structure according to claim 11,
further comprising at least one of a top fuselage portion or a bottom fuselage portion that is arranged adjacent to a first side wall portion and a second side wall portion,
wherein the side wall portions are arranged such that at seat level an inner diameter of the fuselage structure is larger than an inner diameter measured along a direction that does not intersect with the side wall portion.

13. The fuselage structure according to claim 8, wherein the outer skin and the side wall portion are spaced apart by a plurality of at least one of fuselage frames, clips, or stringers.

14. The fuselage structure according to claim 8, wherein a thermal insulation is arranged between the outer skin and a part of the side wall portion or the side wall portion.

15. An aircraft comprising a cabin, wherein a side wall of the cabin has at least one side wall portion according to claim 1.

16. An aircraft comprising a fuselage structure according to claim 8.
